(19) United States
(12) Patent Application Publication
(10) Pub. No.: US 2012/0148240 A1
(43) Pub. Date: Jun. 14, 2012

(54) RESERVING A PATH USING GMPLS EXTENSIONS FOR ODU SIGNALLING

(75) Inventors: Daniele Ceccarelli, Genova (IT); Diego Caviglia, Savona (IT); Francesco Fondelli, Calcinaia (IT)

(73) Assignee: TELEFONAKTIEBOLAGET L M ERICSSON (publ), Stockholm (SE)

(21) Appl. No.: 13/321,042

(22) PCT Filed: Jan. 4, 2010
(86) PCT No.: PCT/EP10/50019

§ 371 Date: Mar. 6, 2012

Related U.S. Application Data
(60) Provisional application No. 61/220,651, filed on Jun. 26, 2009.

(51) Int. Cl. H04J 14/00

(52) U.S. Cl. 398/45

(57) ABSTRACT

A method of requesting reservation of a label switched path (LSP) for traffic of a type compatible with ITU-T G709 amendment 3, in an optical transport network by sending a RSVP-TE path message for the reservation of the requested LSP from an ingress node of the requested path, via intermediate nodes along the path to an egress node, and sending a RSVP-TE resv message from the egress node, to cause the nodes to reserve resources for the requested path. The path message has a signal type field having values assigned to indicate traffic types specified in G.709 amendment 3 beyond those specified by G.709 pre amendment 3, without reuse of values specified by G.709 pre amendment 3. Since the nodes along the path can still distinguish in the signal type field any values of the signal type field specified by G.709 pre amendment 3, new nodes can still work with legacy messages.

### TECHNICAL FIELD

This invention relates to methods of reserving a path in an optical transport network, to nodes of such a network, methods of operating a node, and to corresponding programs.

### BACKGROUND

Optical Transport Networks are known. It is known to have a control plane to control nodes of such networks to reserve (set up) new paths by sending messages between the nodes to reserve resources at each node. This control plane can use Generalized Multi-Protocol Label Switching (GMPLS), which extends MPLS from supporting Packet Switching Capable (PSC) interfaces and switching to include support of four new classes of interfaces and switching: Layer-2 Switching (L2SC), Time-Division Multiplex (TDM), Lambda Switch (LSC), and Fiber-Switch (FSC) Capable.

A functional description of the extensions to MPLS signaling that are needed to support these classes of interfaces and switching is provided in RFC3471, while RFC3473 describes the ReSource reserVation Protocol (RSVP-TE) specific formats and mechanisms needed to support all four classes of interfaces. RFC 4328 presents the technology details that are specific to G.709 Optical Transport Networks (OTN) as specified in the ITU-T G.709 recommendation. Such parameters are carried through the signaling protocol in dedicated traffic parameter objects. Moreover RFC 4328 defines how to encode such labels when these G.709 traffic parameters are used. G.709 defines several networking layers constituting the optical transport hierarchy:
with full functionality: Optical Transmission Section (OTS), Optical Multiplex Section (OMS) and Optical Channel (OCh)
with reduced functionality: Optical Physical Section (OPS), Optical Channel with reduced functionality (OChr)

It also defines two layers constituting the digital transport hierarchy: Optical Channel Transport Unit (OTUk) and Optical Channel Data Unit (ODUk)

In addition to the support of ODUk mapping into OTUk (k=1, 2, 3), G.709 supports ODUk multiplexing. It refers to the multiplexing of ODUj (j=1, 2) into an ODUk (k>j) signal, in particular:
ODU1 into ODU2 multiplexing
ODU1 into ODU3 multiplexing
ODU2 into ODU3 multiplexing
ODU1 and ODU2 into ODU3 multiplexing

RFC 4328 adapts GMPLS to control G.709 type OTNs, creating:
a Digital Path layer corresponding to the ODUk (digital) path layer.
an Optical Path layer corresponding to the OCh (optical) path layer.
a label space structure enabling the identification of the exact position of a particular ODUj signal in an ODUk multiplexing structure.

Thus, the GMPLS signaling extensions for G.709 need to cover the messages such as Generalized Label Requests, used to request capacity at nodes along the path as well as the specific technology dependent objects included in the so-called traffic parameters for SONET/SDH networks. Moreover, RFC 4328 also proposes a label space definition suitable for that purpose.

The Generalized Label Request is a message used by RSVP-TE for the signaling of a Label Switched Path (LSPs) on any kind of network technology. It is defined in RFC3471 and extended in RFC 4328 in order to support G.709 OTN architecture. It includes a common part (i.e., used for any switching technology) and a technology dependent part (i.e., the traffic parameters). RFC 4328 extends both parts to accommodate GMPLS Signaling to the G.709 transport plane recommendation.

To reserve a path, an RSVP-TE path message, in the form of a Generalised Label Request, is sent out from an ingress node via intermediate nodes along the proposed path, to an egress node. The egress node returns an RSVP-TE resv message to the ingress node, back along the path to cause the nodes along the path to reserve resources for the requested path, for traffic of a signal type specified in the message.

### SUMMARY OF THE INVENTION

An object of the invention is to provide improved apparatus or methods. According to a first aspect, the invention provides:

A method of requesting reservation of a label switched path (LSP) for traffic of a type compatible with ITU-T G.709 amendment 3, in an optical transport network having a number of nodes, the method having the step of: sending a RSVP-TE path message for the reservation of the requested LSP from an ingress node of the requested path, via intermediate nodes along the path to an egress node. A further step is sending a RSVP-TE resv message from the egress node, back along the path to cause the nodes along the path to reserve resources for the requested path, for traffic of a signal type specified in G.709 amendment 3 beyond types previously specified by G.709 pre amendment 3. In this method, the path message has an indication of traffic parameters for the requested LSP including a signal type field, the signal type field having values assigned to indicate traffic types specified in G.709 amendment 3 beyond those specified by G.709 pre amendment 3, without reuse of values specified by G.709 pre amendment 3, so that the nodes along the path can still distinguish in the signal type field any values of the signal type field specified by G.709 pre amendment 3.

This can enable paths to use the new signal types, and by not reusing the values recognised by legacy nodes, new nodes can be introduced which will still work with legacy messages sent out by the legacy nodes. Hence upgrades can be implemented more gradually or in piecemeal stages. Whereas, if any of the old values are reused, then compatibility with legacy nodes is more complex, either the new nodes need to be told which other nodes are legacy nodes, sending old messages, or some other version recognition is needed in the messages, which implies the legacy nodes need some modification.

Any additional features can be added to those discussed above, and some are described in more detail below.

Another aspect of the invention can involve a correspond method of operating a node of such an optical transport network, or a node arranged to act as the ingress node, or intermediate node, or egress node respectively.

Any of the additional features can be combined together and combined with any of the aspects. Other advantages will be apparent to those skilled in the art, especially over other prior art. Numerous variations and modifications can be made without departing from the claims of the present invention. Therefore, it should be clearly understood that the form of the present invention is illustrative only and is not intended to limit the scope of the present invention.

### BRIEF DESCRIPTION OF THE DRAWINGS

How the present invention may be put into effect will now be described by way of example with reference to the appended drawings, in which:

FIG. 1 shows a schematic view of a part of an optical transport network having nodes according to an embodiment,

FIGS. 2 to 4 show sequence charts for sequences of operations of the nodes of the embodiment of FIG. 1 or of other embodiments, and

FIGS. 5 to 7 show structures of messages used in the embodiments of FIGS. 1 to 4 or other embodiments.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

### DEFINITIONS

Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

The term “comprising”, used in the claims, should not be interpreted as being restricted to the means listed thereafter; it does not exclude other elements or steps.

Elements or parts of the described nodes or networks may comprise logic encoded in media for performing any kind of information processing. Logic may comprise software encoded in a disk or other computer-readable medium and/or instructions encoded in an application specific integrated circuit (ASIC), field programmable gate array (FPGA), or other processor or hardware.

References to nodes can encompass any kind of node, not limited to the types described, not limited to any level of integration, or size or bandwidth or bit rate and so on. References to software can encompass any type of programs in any language executable directly or indirectly on processing hardware.

References to hardware, processing hardware or circuitry can encompass any kind of logic or analog circuitry, integrated to any degree, and not limited to general purpose processors, digital signal processors, ASICs, FPGAs, discrete components or logic and so on.

References to resources is intended to encompass any resources needed to use the path to transmit traffic, including for example links and cross-connections on label switched routers (LSRs).

References to LSRs can encompass switches, routers, optical switches or other devices at nodes along a path.

### Introduction

By way of introduction to the embodiments, some issues with conventional designs will be explained.

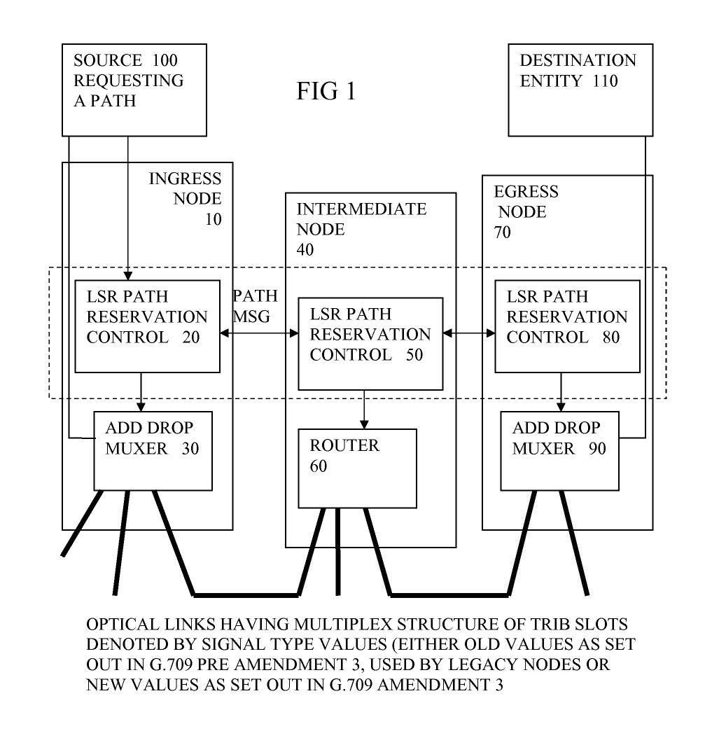

FIG. 1, overall view of nodes which can be according to embodiments of the invention FIG. 1 shows parts of an optical transport network. Three nodes are shown, there can be many more. An ingress node 10 has an LSR path reservation control part 20, which controls an add drop multiplexer part 30. An intermediate node 40 has its own LSR path reservation control part 50, which controls a router 60. An egress node 70 has its own LSR path reservation control part 80, which controls its add drop multiplexer 90. A source entity 100 is shown, as a source of the traffic for which the new path is needed, through the network to a destination entity 110.

Optical links are shown for carrying the traffic between the nodes, and a connection is shown between the control parts of the nodes for passing messages to reserve the path. This connection can in principle use either the same or different physical links to those used by the traffic between nodes. The optical links for the traffic have a multiplex structure of trib slots. A path can use one or more of these trib slots, and a reservation procedure needs to indicate which of these trib slots is reserved.

To explain how the embodiments can provide an improved path reservation process, first a conventional message structure will be described. A first step is the source entity requesting a new label switched path (LSP) from a first node to another node. This first node can be any node which has add or transmit capability, and this now becomes referred to the ingress node for this path. The second node can be any node which has a drop or receive capability, and this now becomes referred to as the egress node for this path. The request can be authorized by a network management system, or by a human operator, and a route to the destination or egress node can be determined. Then a command goes to the ingress node to reserve the path.

The ingress node issues an RSVP-TE path message in the form of a generalised label request, for the reservation of the requested LSP, to a next node along the designated path. Each node passes the message on if it recognises it and has capacity to meet the request, in terms of bandwidth along links and capacity through optical switches or routers and so on. Otherwise any intermediate node may return an error message and the ingress node or the network management system can react accordingly, to try a different path for example, or provide an indication to the source.

If the path message reaches the egress node, then the egress node returns an RSVP-TE resv message from the egress node, in the form of a generalised label, back along the path to cause the nodes along the path to reserve resources for the requested path, for traffic of a signal type specified by the path message, in a trib slot or slots specified by the resv message. Each intermediate node along the path passes the message along if it can make the reservation, or issues an error message. If the resv message reaches the ingress node, that indicates that the path has been successfully reserved and can be used for traffic, so this is indicated to the source entity. More details of the structure of these messages will now be explained, so that the significance of differences in structure according to embodiments will become clearer.

Common part of the Label Request

As defined in RFC3471, the LSP Encoding Type, the Switching Type and the Generalized Protocol Identifier (Generalized-PID) constitute the common part of the Generalized Label Request.

### LSP Encoding Type

This field indicates the encoding of the LSP being requested. RFC 4328 defines two new values concerning the Digital (ODUk) and the Optical (OCh) path respectively: 12—G.709 ODUk (Digital Path) 13—G.709 Optical Channel

### Switching Type

The Switching Type indicates the type of switching that should be performed at the termination of a particular link (see [RFC4202]). ODUk switching belongs to the TDM class, while an OCh switching belongs to the Lambda class defined in RFC 4371.

### Generalized-PID (G-PID)

The G-PID (16 bits field), as defined in [RFC3471], identifies the payload carried by an LSP, i.e., an identifier of the client layer of that LSP. This identifier is used by the endpoints of the G.709 LSP.

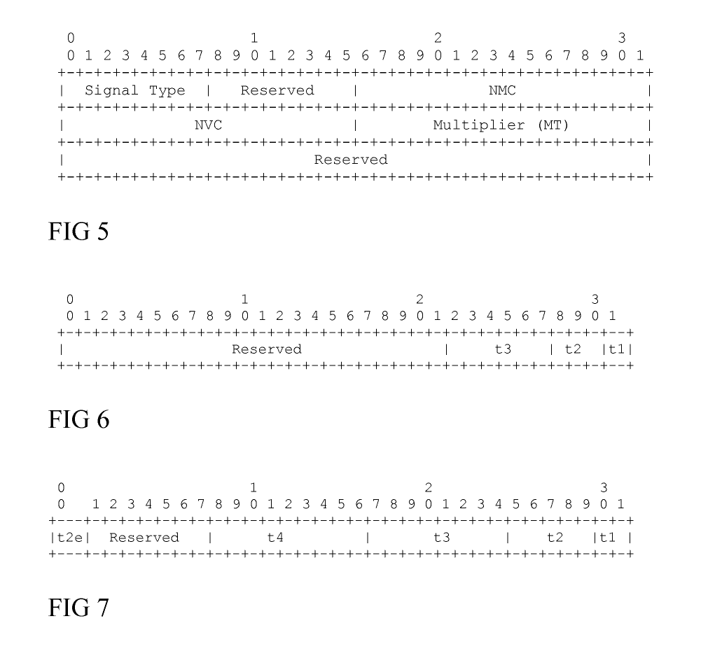

FIG. 5, Technology Dependent Part of the Path Message—g.709 Traffic parameters

When the G.709 Digital Path Layer or G.709 Optical Channel Layer is specified in the LSP Encoding Type field, the information referred to as technology dependent (or simply traffic parameters) is carried additionally to the one included in the Generalized Label Request.

The G.709 traffic parameters are defined by a frame having a structure as shown in FIG. 5. In this frame, NMC stands for Number of Multiplexed Components, NVC for Number of Virtual Components, and MT for Multiplier. Each of these fields is tailored to support G.709 LSP requests.

### Signal Type (ST)

This field (8 bits) indicates the type of G.709 Elementary Signal that comprises the requested LSP. The permitted values are as follows:
0 Not significant
ODU1 (i.e., 2.5 Gbps)
ODU2 (i.e., 10 Gbps)
3 ODU3 (i.e., 40 Gbps)
4 Reserved (for future use)
5 Reserved (for future use)
6 OCh at 2.5 Gbps
7 OCh at 10 Gbps
8 OCh at 40 Gbps
9-255 Reserved (for future use)

Several transforms can be sequentially applied on the Elementary Signal to build the Final Signal that is actually requested for the LSP. Transforms must be applied strictly in the following order:
First, virtual concatenation (by using the NVC field) can be optionally applied directly on the Elementary Signal to form a Composed Signal
Second, a multiplication (by using the Multiplier field) can be optionally applied, either directly on the Elementary Signal, or on the virtually concatenated signal obtained from the first phase. The resulting signal is referred to as Final Signal.

### Number of Multiplexed Components (NMC)

The NMC field (16 bits) indicates the number of ODU tributary slots used by an ODUj when multiplexed into an ODUk (k>j) for the requested LSP.

### Number of Virtual Components (NVC)

The NVC field (16 bits) is dedicated to ODUk virtual concatenation (i.e., ODUk Inverse Multiplexing) purposes. It indicates the number of ODU1, ODU2, or ODU3 Elementary Signals that are requested to be virtually concatenated to form an ODUk-Xv signal. By definition, these signals MUST be of the same type.

### Multiplier (MT)

The Multiplier field (16 bits) indicates the number of identical Elementary Signals or Composed Signals that are requested for the LSP, i.e., that form the Final Signal. A Composed Signal is the resulting signal from the application of the NMC and NVC fields to an elementary Signal Type. GMPLS signaling currently implies that all the Composed Signals must be part of the same LSP.

### Reserved Fields

The reserved fields (8 bits in row 1 and 32 bits in row 3) are dedicated for future use.

### FIG. 6, Resv Message (Generalized Label) for Pre Amendment 3

This section describes the Generalized Label value space for Digital Paths and Optical Channels.

### ODUk Label Space

When RFC 4328 was written, at the Digital Path layer (i.e., ODUk layers), G.709 defined three different client payload bit rates. An Optical Data Unit (ODU) frame has been defined for each of these bit rates. ODUk refers to the frame at bit rate k, where k=1 (for 2.5 Gbps), 2 (for 10 Gbps), or 3 (for 40 Gbps). In addition to the support of ODUk mapping into OTUk, the G.709 label space supports the sub-levels of ODUk multiplexing. ODUk multiplexing refers to multiplexing of ODUj (j=1, 2) into an ODUk (k>j), in particular:
ODU1 into ODU2 multiplexing
ODU1 into ODU3 multiplexing
ODU2 into ODU3 multiplexing
ODU1 and ODU2 into ODU3 multiplexing

More precisely, ODUj into ODUk multiplexing (k>j) is defined when an ODUj is multiplexed into an ODUk Tributary Unit Group (i.e., an ODTUG constituted by ODU tributary slots) that is mapped into an OPUk. The resulting OPUk is mapped into an ODUk, and the ODUk is mapped into an OTUk (see FIG. 1).

A G.709 Digital Path layer label identifies the exact position of a particular ODUj signal in an ODUk multiplexing structure. The G.709 Digital Path Layer label or ODUk label has the format shown in FIG. 6. As shown, the specification of the fields t1, t2, and t3 self-consistently characterizes the ODUk label space. The value space for the t1, t2, and t3 fields is defined as follows:
1. t1 (1-bit):
   t1=1 indicates an ODU1 signal.
2. t2 (3-bit):
   t2=1 indicates an ODU2 signal that is not further sub-divided.
   t2=[2..5] indicates the tributary slot used by the ODU1 in an ODTUG2 mapped into an ODU2 (via OPU2).
   t2 is not significant for an ODU3
3. t3 (6-bit):
   t3=1 indicates an ODU3 signal that is not further sub-divided.
   t3=[2..17] indicates the tributary slot used by the ODU1 in an ODTUG3 mapped into an ODU3 (via OPU3).
   t3=[18..33] indicates the tributary slot used by the ODU2 in an

ODTUG3 mapped into an ODU3 (via OPU3).

### Examples:

t3=0, t2=0, t1=1 indicates an ODU1 mapped into an OTU1
t3=0, t2=1, t1=0 indicates an ODU2 mapped into an OTU2
t3=1, t2=0, t1=0 indicates an ODU3 mapped into an OTU3
t3=0, t2=3, t1=0 indicates the ODU1 in the second tributary slot of the ODTUG2 mapped into an ODU2 (via OPU2) mapped into an OTU2
t3=5, t2=0, t1=0 indicates the ODU1 in the fourth tributary slot of the ODTUG3 mapped into an ODU3 (via OPU3) mapped into an OTU3

Existing solutions (RFC 4328, RFC 3471 and RFC3473) provide means to signal ODU1, ODU2 and ODU3 signal where the tributary slot (TS) granularity is implicitly granted at 2.5 Gbps.

### Introduction to Features of the Embodiments

G.709 Amendment 3 defines also ODU0, ODU4, ODUflex and ODUe2 digital signals and introduces a new tributary slot granularity of 1.25 Gbps. No means to signal them in the sense of reserving paths for them has been considered or standardized yet.

If the meanings of some of the signal type values were to be changed from the meanings defined in G.709 pre amendment 3, then an intermediate node would need to know which version of signal type values is being used, the new values (G.709 amendment 3) or old values (G.709 pre amendment 3).

By maintaining the old values for the signal type and using new values for the added meanings relating to G709 amendment 3 signal types, then there is no need for a separate mechanism to make nodes aware of which version is being used. Notably, new nodes can still recognise and work with old messages, without generating errors. And old nodes can still recognise the old values in new style messages.

Maintaining the signal type values as defined in rfc4328, means that no version bit is necessary, and that nodes can be updated to this new method without disrupting the operation of other nodes using the older method, so an upgrade can be phased in more easily.

At least some embodiments of the invention involve extending the path message (some examples of which have a Generalized Label Request Object) and the resv message (some examples of which have a Generalized Label) in order to provide a means for signaling a wider range of signal types of the ODU multiplex hierarchy, than the old signal types (e.g. ODU1, ODU2, ODU3). This can include signaling the old signal types with more granularity (i.e. 1.25 Gbps Trib Slot (TS) granularity), or new signal types (i.e. ODU0, ODU2e, ODU4 and ODUflex) and all the possible concatenations and multiplexing combinations of ODUk in ODUj with k>j.

With respect to the Generalized Label Request parameters only the Signal Type field of the technology dependent part needs to be updated by defining new values of this field. Such new values can include some or all of the following:
4—ODU4 (i.e., 100 Gbps)
9—Och at 100 Gbps
10—ODU0 (i.e., 1.25 Gbps)
15—ODUflex (i.e., 1.25*ts Gbps→0x0f
47—ODU2e (i.e, 11,1 Gbps)→0x2e

On the other side a new Generalized Label needs to be defined for the Resv message, because in the existing one only ODU1, ODU2 and ODU3 with 2.5 Gbps TS granularity support is foreseen. The new structure of this label will allow reservation of resources (signaling) also ODU0, ODU2e, ODU4 and ODUflex and ODU1, ODU2 and ODU3 with 1.25 Gbps TS granularity.

The old label will be called “G.709 Digital Path layer label” as usual, while the new one will be called “G.709 Amendment 3 Digital Path layer label”. The Generalized Label to be used is identified by the Signal Type+NMC field combination:

### Examples:

ST=2 and NMC=4→G.709 Digital Path layer label
ST=2 and NMC=8→G.709 Amendment 3 Digital Path layer label
ST=4, 10, 15, 47→G.709 Amendment 3 Digital Path layer label.

If a legacy node (network element) (i.e. a node not able to read the new generalized label defined above) receives a combination of ST and NMC fields identifying the new label, it must generate a PathErr message with a “Traffic Control Error/Service unsupported indication” (as per RFC 4328 section 6).

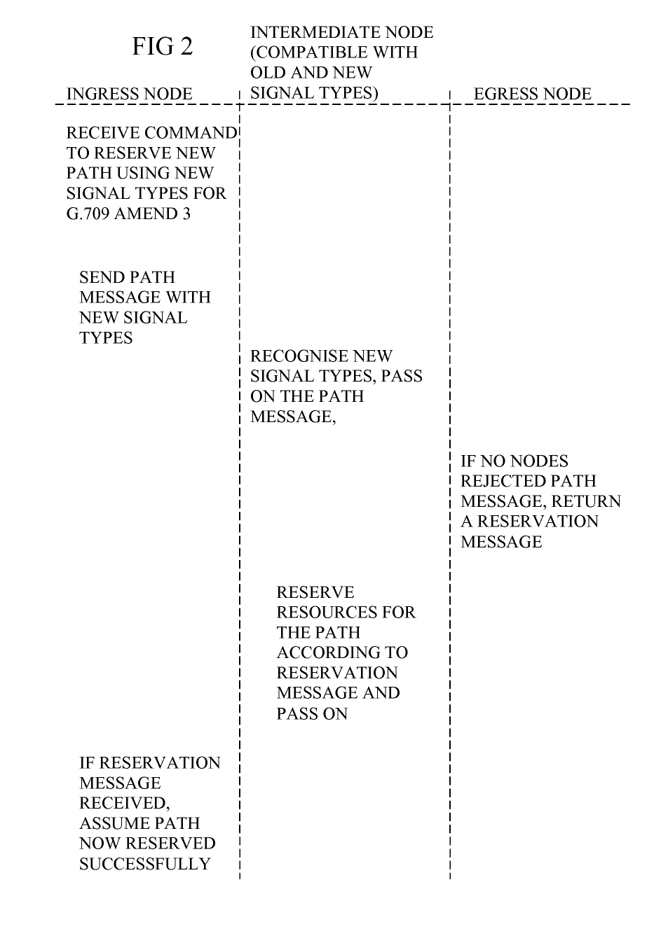

### FIGS. 2,3,4, Message Sequences According to Embodiments

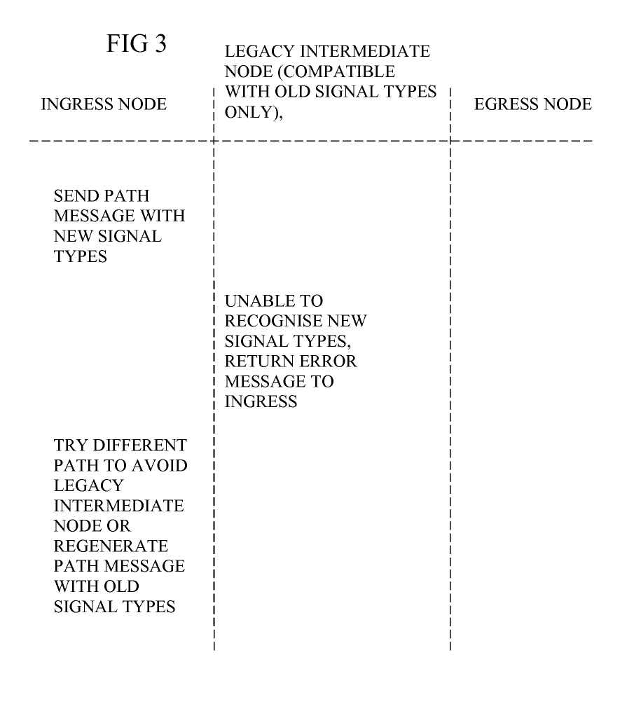

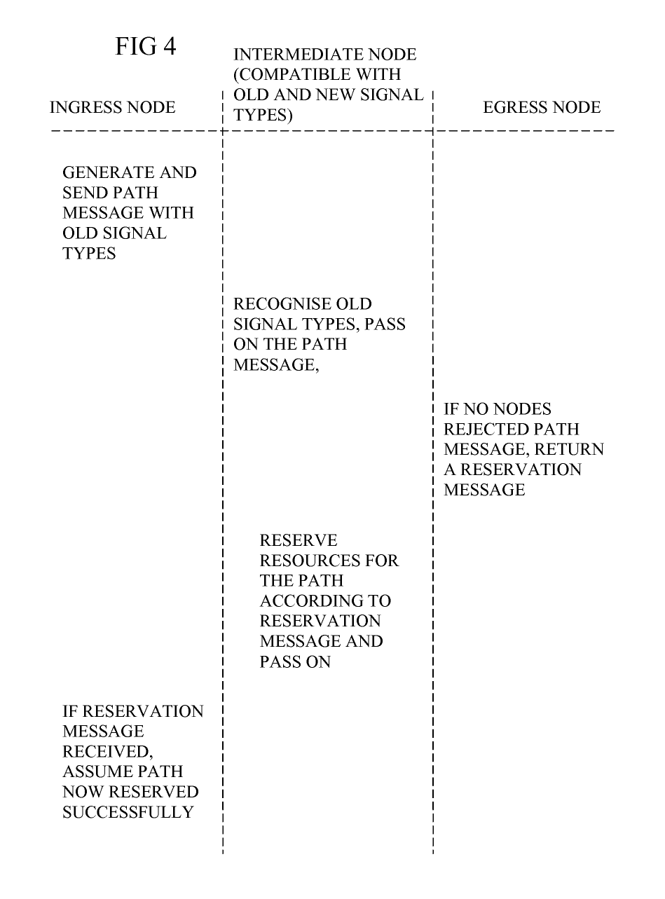

FIGS. 2, 3 and 4 show sequences of messages for three different cases, to highlight how the backward compatibility can be improved by not reusing old signal values. In each case, there are three columns shown, to separate actions at ingress node, intermediate node and egress node respectively, and time flows down the page. FIG. 2 shows using new signal type values, with new nodes, FIG. 3 shows using new signal type values for a legacy intermediate node, and FIG. 4 shows old signal type values for new intermediate node. FIG. 4 shows a sequence which would not be possible if old signal values were reused, as will be explained.

FIG. 2 shows at the ingress node receiving a command to reserve a new path using new signal types for G.709 amendment 3. In a typical network the command to configure the nodes can come in two ways, either via a network management system, which is a software tool running on a network server and able to access all the nodes of the network. This can have a graphic user interface, to enable operator input. Or an operator can use a command line interface (CLI) which is a software tool providing connectivity more directly to any particular remote node.

A path message is therefore sent out from the ingress node with the new signal types. This is received at the intermediate node which is compatible with old and new signal types. Since the new signal types are recognized, the intermediate node passes on the message. If no nodes rejected the message, it is received at the egress node and a reservation resv message is returned. This is received and recognized at the intermediate node, and the appropriate resources are reserved. The message is passed on and reaches the ingress node which can assume that the path is successfully set up.

FIG. 3 shows a case in which the intermediate node is an old legacy node, compatible with old signal types only. The ingress node sends a path message with new signal types, but this is not recognized at the intermediate node. The intermediate node sends back an error message. In response the ingress node may alert the source entity, or may try a different path to avoid the legacy intermediate node, or may regenerate the path message using old signal types.

FIG. 4 shows an example in which the intermediate node is compatible with old and new signal types, but the ingress node sends an old signal type message, perhaps because it is a legacy node, not compatible with the new signal types. The intermediate node is a node according to an embodiment, compatible with old and new signal types. This intermediate node recognizes the old signal type, and passes on the path message.

As before, if no nodes rejected the path message, the egress node will return a reservation message back to the ingress node. This is received and recognized at the intermediate node, and the appropriate resources are reserved. The message is passed on and reaches the ingress node which can assume that the path is successfully set up. By having the new signal types specified in such a way that the old values are not reused, this enables the intermediate node to be able to recognize the old signal types as sent by a legacy node. This means the new nodes can be introduced piecemeal into an existing network and thus an upgrade can be implemented in stages, which is preferable to having to upgrade all nodes at once, to limit the risk of problems or instability into the network.

### FIG. 7, Generalised Label Object Structure According to an Embodiment

Some examples of the Resv message can include a generalized label object. In FIG. 7, there are fields in the object shown as t1, t2, t3, t4 and t2e. The meanings of the various possible values of these fields will now be explained.

1. t1 (2-bit):
t1=[1..2] indicates the tributary slot (t1th) used by the ODU0 (via ODTU01) in an ODTUG1 mapped into an ODU1 (via OPU1).—t1 is not significant for the other ODUk signal types (i.e., t1 value MUST be set to 0 and ignored).
   2. t2 (5-bit):
t2=[1..8] indicates the tributary slot (t2th) used by the ODU0 (via ODTU02) in an ODTUG2 mapped into an ODU2 (via OPU2).
t2=[9..16] indicates the tributary slot (t2th-8) used by the ODU1 (via ODTU12) in an ODTUG2 mapped into an ODU2 (via OPU2).
t2=[17..24] indicates the tributary slot (t2th-16) used by the ODUflex (via ODTU2.ts) in an ODTUG2 mapped into an ODU2 (via OPU2).
t2 is not significant for the other ODUk signal types (i.e., t2 value MUST be set to 0 and ignored).
   3. t3 (8-bit):
t=[1..32] indicates the tributary slot (t3th) used by the ODU0 (via ODTU03) in an ODTUG3 mapped into an ODU3 (via OPU3).
t3=[33..64] indicates the tributary slot (t3th-32) used by the ODU1 (via ODTU13) in an ODTUG3 mapped into an ODU3 (via OPU3).
t3=[65..96] indicates the tributary slot (t3th-64) used by the ODU2 (via ODTU23) in an ODTUG3 mapped into an ODU3 (via OPU3).
t3=[97..128] indicates the tributary slot (t3th-96) used by the ODUflex (via ODTU3.ts) in an ODTUG3 mapped into an ODU3 (via OPU3).
t3=[129..144] indicates the tributary slot (t3th-128) used by the ODU2e (via ODTU2e3) in an ODTUG3 mapped into an ODU3 (via OPU3).
t3 is not significant for the ODU4 signal type (i.e., t3 value MUST be set to 0 and ignored).
   4. t4 (9-bit):
t4=1 indicates an ODU4 signal
t4=[2..81] indicates the tributary slot (t4th-1) used by the ODU0 (via ODTU4.1) in an ODTUG4 mapped into an ODU4 (via OPU4).
t4=[82..161] indicates the tributary slot (t4th-81) used by the ODU1 (via ODTU4.2) in an ODTUG4 mapped into an ODU4 (via OPU4).

t4=[162..241] indicates the tributary slot (t4th-161) used by the ODU2 (via ODTU4.8) in an ODTUG4 mapped into an ODU4 (via OPU4).
t4=[242..321] indicates the tributary slot (t4th-241) used by the ODU3 via ODTU4.32) in an ODTUG4 mapped into an ODU4 (via OPU4).
t4=[322..401] indicates the tributary slot (t4th-321) used by the ODUflex (via ODTU4.ts) in an ODTUG4 mapped into an ODU4 (via OPU4).
t4=[402..481] indicates the tributary slot (t4th-401) used by the ODU2e (via ODTU4.8) in an ODTUG4 mapped into an ODU4 (via OPU4).
   5. t2e (1-bit):
t2e=1 indicates an ODU2e signal.
t2e is not significant for the other ODUk signal types (i.e., t1 value MUST be set to 0 and ignored).

Some additional features of some embodiments

In addition to the indication of the new signal types, in some embodiments the resv message can have an indication of a position of each optical data unit in an optical data unit multiplex structure, to a granularity of approximately 1.25 Gbps or finer. This can increase the flexibility and increase the number of positions in the multiplex structure. The nodes can be arranged to deduce whether the path message relates to a path for traffic of a signal type specified in G.709 amendment 3 beyond types previously specified by G.709 pre amendment 3, or for traffic of a signal type specified by G.709 pre amendment 3, without the use of a bit in the message dedicated to indicate this. This can simplify the nodes, and reduce waste of bandwidth in overhead. The signal types specified in G.709 amendment 3 beyond types previously specified, can comprise any one of more of the following: ODUs previously specified pre amendment 3, but at a finer level of granularity than previously specified, ODU0, ODU2e, ODU4 and ODUflex. This can provide increased options for traffic, to suit application needs.

The resv message can have a field to indicate a signal type of ODU2e. ODU2e can use a dedicated field because it cannot be multiplexed into higher order ODUx signal type nor include low order ODUx signal types).

In some embodiments a method of operating a node of the optical transport network as an intermediate node is provided, to reserve a label switched path (LSP) for traffic of a type compatible with G709 amendment 3, the method having the steps of: receiving a path message for the reservation of the requested path, sent from an ingress node of the requested path, towards an egress node, passing the path message on towards the egress node, receiving a resv message sent from the egress node back along the path, and reserving resources for the requested path, for traffic of a signal type specified in G.709 amendment 3 beyond types previously specified by G.709 pre amendment 3, wherein the path message has an indication of traffic parameters for the requested path including a signal type field, the signal type field having values assigned to indicate traffic types specified in G.709 amendment 3 beyond those specified by G.709 pre amendment 3, without reuse of values specified by G.709 pre amendment 3, the node being arranged to distinguish in the signal type field any values of the signal type field specified by G.709 pre amendment 3. The node can have software executable by a computer at a node to carry out the steps of the method.

Other embodiments include a node of the optical transport network, the node being able to act as an ingress node and to reserve a path for traffic of a type compatible with G709 amendment 3, the node having: a part arranged to send a path message for the reservation of the requested LSP from the node, via intermediate nodes along the LSP to an egress node, and a part arranged to receive a resv message sent back from the egress node, back along the path, and to reserve resources for the requested path, for traffic of a signal type specified in G.709 amendment 3 beyond types previously specified by G.709 pre amendment 3, wherein the path message has an indication of traffic parameters for the requested path including a signal type field, the signal type field having values assigned to indicate traffic types specified in G.709 amendment 3 beyond those specified by G.709 pre amendment 3, without reuse of values specified by G.709 pre amendment 3, so that the node can still distinguish in the signal type field any values of the signal type field specified by G.709 pre amendment 3. Again these parts can be implemented by software.

Another embodiment involves a node able to act as an egress node in reserving a path for traffic of a type compatible with G709 amendment 3, the node having: a part arranged to receive a path message sent from an ingress node, for the reservation of the requested path from the ingress node, via intermediate nodes along the path to the node, and a part arranged to send a resv message back along the path, and to reserve resources for the requested path, for traffic of a signal type specified in G.709 amendment 3 beyond types previously specified by G.709 pre amendment 3, wherein the path message has an indication of traffic parameters for the requested path including a signal type field, the signal type field having values assigned to indicate traffic types specified in G.709 amendment 3 beyond those specified by G.709 pre amendment 3, without reuse of values specified by G.709 pre amendment 3, so that the node can still distinguish in the signal type field any values of the signal type field specified by G.709 pre amendment 3.

Another embodiment involves a node able to act as an intermediate node in reserving a path for traffic of a type compatible with G709 amendment 3, the node having: a part arranged to receive and pass on a path message sent from an ingress node, for the reservation of the requested path from the ingress node, via intermediate nodes along the path to an egress node, and a part arranged to receive and pass on a resv message sent from the egress node back along the path, and to reserve resources for the requested LSP, for traffic of a signal type specified in G.709 amendment 3 beyond types previously specified by G.709 pre amendment 3, wherein the path message has an indication of traffic parameters for the requested path including a signal type field, the signal type field having values assigned to indicate traffic types specified in G.709 amendment 3 beyond those specified by G.709 pre amendment 3, without reuse of values specified by G.709 pre amendment 3, so that the node can still distinguish in the signal type field any values of the signal type field specified by G.709 pre amendment 3.

As described, some embodiments can be very useful for signaling GMPLS controlled Optical Transport Networks so as to include signaling recently standardized ODU0, ODU2e, ODU4 and ODUflex digital signals of the G.709 hierarchy and ODU1, ODU2 and ODU3 with 1.25 Gbps TS granularity.

Other Embodiments, or Features which can be Added to Aspects Described Above:

A method can involve setting up a label switched path across an optical transport network having a number of nodes interconnected by data links, the method comprising:
generating a label datastructure at a first node, the label datastructure identifying one or more tributary slots of a frame which are allocated to carrying traffic associated with the label switched path between the first node and a second node over a said data link; transmitting the label datastructure from the first node to the second node;

wherein the label datastructure comprises an array of bit elements grouped into at least four fields corresponding to respective frame types, a non-zero value of the bit elements in one of the fields indicating the frame type allocated to the frame, and the non-zero value indicating the tributary slots allocated within the frame.

Another method involves the above method, wherein: the frame types comprise ODU1, ODU2, ODU3, ODU4, ODUflex according to G.709; the tributary slots comprise a bandwidth of 1.25 Gb/s and/or 2.5 Gb/s, the array of bit elements comprises 32 bits having: a first field of 2 bits corresponding to ODU1, a second field of 5 bits corresponding to ODU2, a third field of 8 bits corresponding to ODU3, and a fourth field of 9 bits corresponding to ODU4.

Another method involves the above method, wherein the array of bit elements further having a fifth field comprising 1 bit corresponding to an ODU2e frame type. Another method involves the above method, wherein in the first field: values 1-2 indicate the tributary slot used by an ODU0 mapped into an ODU1.

Another method according to any of the above methods, wherein in the second field: values 1-8 indicate the tributary slot used by an ODU0 mapped into an ODU2; values 9-16 indicate the tributary slot used by an ODU1 mapped into an ODU2; values 1-8 indicate the tributary slot used by an ODUflex mapped into an ODU2.

Another method according to any one of the above methods, wherein in the third field: values 1-32 indicate the tributary slot used by an ODU0 mapped into an ODU3; values 33-64 indicate the tributary slot used by an ODU1 mapped into an ODU3; values 65-96 indicate the tributary slot used by an ODU2 mapped into an ODU3; values 97-128 indicate the tributary slot used by an ODUflex mapped into an ODU3; values 129-144 indicate the tributary slot used by an ODU2e mapped into an ODU3.

Another method according to any one of the above methods, wherein in the fourth field: values 1-81 indicate the tributary slot used by an ODU0 mapped into an ODU4; values 82-161 indicate the tributary slot used by an ODU1 mapped into an ODU4; values 162-241 indicate the tributary slot used by an ODU2 mapped into an ODU4; values 242-321 indicate the tributary slot used by an ODU3 mapped into an ODU4; values 322-401 indicate the tributary slot used by an ODUflex mapped into an ODU4; values 402-481 indicate the tributary slot used by an ODU2e mapped into an ODU4.

Another method according to any one preceding method, wherein the label datastructure is transmitted as part of a GMPLS/RSVP-TE generalised label signalling message.

Another method according to any one preceding method, further comprising first receiving a request for setting up the label switched path from a label switched path ingress node, and determining whether the first node can allocate the one or more tributary slots to carry the traffic associated with the label switched path over the data link to the second node.

Another method according to any one preceding method, further comprising: first receiving another label datastructure from an downstream node which is downstream of the first node in the label switched path; determining from the other datastructure the traffic associated with the label switched path and determining whether the first node can allocate one or more tributary slots to carry said traffic.

Another method according to the preceding method, further comprising: receiving traffic over a data link from the downstream node on tributary slots identified in the other label structure; switching the traffic to tributary slots identified in the first label structure and transmitting the traffic over the data link between the first and second nodes.

A network node for setting up a label switched path across an optical transport network having a number of nodes interconnected by data links, the network node comprising: a processor arranged to generate a label datastructure, the label datastructure identifying one or more tributary slots of a frame which are allocated to carrying traffic associated with the label switched path between the network node and a second node over a said data link; a transmitter arranged to transmit the label datastructure from the network node to the second node; wherein the label datastructure comprises an array of bit elements grouped into at least four fields corresponding to respective frame types, a non-zero value of the bit elements in one of the fields indicating the frame type allocated to the frame, and the non-zero value indicating the tributary slots allocated within the frame.

A control signal for setting up a label switched path across an optical transport network having a number of nodes interconnected by data links, the signal comprising: an array of bit elements grouped into at least four fields corresponding to respective frame types; a non-zero value of the bit elements in one of the fields indicating the frame type allocated to a frame for carrying traffic associated with the label switched path between a first node and a second node; the non-zero value indicating the tributary slots allocated within the frame.

Machine-readable instructions for causing a processor to execute any one of the above methods.

Other variations and embodiments can be envisaged within the claims.

1. A method of requesting reservation of a label switched path (LSP) for traffic of a type compatible with ITU-T G.709 amendment 3, in an optical transport network having a number of nodes, the method having the steps of:
sending a RSVP-TE path message for the reservation of the requested LSP from an ingress node of the requested path, via intermediate nodes along the path to an egress node, and
sending a RSVP-TE resv message from the egress node, back along the path to cause the nodes along the path to reserve resources for the requested path, for traffic of a signal type specified in G.709 amendment 3 beyond types previously specified by G.709 pre amendment 3,
wherein the path message has an indication of traffic parameters for the requested LSP including a signal type field, the signal type field having values assigned to indicate traffic types specified in G.709 amendment 3 beyond those specified by G.709 pre amendment 3, without reuse of values specified by G.709 pre amendment 3, so that the nodes along the path can still distinguish in the signal type field any values of the signal type field specified by G.709 pre amendment 3.

2. The method of claim 1, the resv message having an indication of a position of each optical data unit in an optical data unit multiplex structure, to a granularity of approximately 1.25 Gbps or finer.

3. The method of claim 1, the nodes being arranged to deduce whether the path message relates to a path for traffic of a signal type specified in G.709 amendment 3 beyond types previously specified by G.709 pre amendment 3, or for traffic of a signal type specified by G.709 pre amendment 3, without the use of a bit in the message dedicated to indicate this.

4. The method of claim 1, the signal types specified in G.709 amendment 3 beyond types previously specified, comprising any one of more of the following: ODUs previously specified pre amendment 3, but at a finer level of granularity than previously specified, ODU0, ODU2e, ODU4 and ODUflex.

5. The method of claim 4, the resv message having a field to indicate a signal type of ODU2e.

6. A method of operating a node of an optical transport network having a number of nodes, to reserve a label switched path (LSP) for traffic of a type compatible with G709 amendment 3, the method having the steps of:
receiving a path message for the reservation of the requested path, sent from an
ingress node of the requested path, towards an egress node,
passing the path message on towards the egress node,
receiving a resv message sent from the egress node back along the path, and
reserving resources for the requested path, for traffic of a signal type specified in G.709 amendment 3 beyond types previously specified by G.709 pre amendment 3,
wherein the path message has an indication of traffic parameters for the requested path including a signal type field, the signal type field having values assigned to indicate traffic types specified in G.709 amendment 3 beyond those specified by G.709 pre amendment 3, without reuse of values specified by G.709 pre amendment 3, the node being arranged to distinguish in the signal type field any values of the signal type field specified by G.709 pre amendment 3.

7. The method of claim 6, the resv message having an indication of a position of each optical data unit in an optical data unit multiplex structure, to a granularity of approximately 1.25 Gbps or finer.

8. The method of claim 6, the node being arranged to deduce whether the path message relates to a LSP for traffic of a signal type specified in G.709 amendment 3 beyond types previously specified by G.709 pre amendment 3, or for traffic of a signal type specified by G.709 pre amendment 3, without the use of a bit in the message dedicated to indicate this.

9. A program on a computer readable medium and being executable by a computer at a node to cause the computer to carry out the steps of the method of claim 6.

10. A node of an optical transport network having a number of nodes, the node being able to act as an ingress node and reserve a path for traffic of a type compatible with G709 amendment 3, the node having:
a part arranged to send a path message for the reservation of the requested LSP from the node, via intermediate nodes along the LSP to an egress node, and
a part arranged to receive a resv message sent back from the egress node, back along the path, and to reserve resources for the requested path, for traffic of a signal type specified in G.709 amendment 3 beyond types previously specified by G.709 pre amendment 3,
wherein the path message has an indication of traffic parameters for the requested path including a signal type field, the signal type field having values assigned to indicate traffic types specified in G.709 amendment 3 beyond those specified by G.709 pre amendment 3, without reuse of values specified by G.709 pre amendment 3, so that the node can still distinguish in the signal type field any values of the signal type field specified by G.709 pre amendment 3.

11. A node of an optical transport network having a number of nodes, the node being able to act as an egress node in reserving a path for traffic of a type compatible with G709 amendment 3, the node having:
a part arranged to receive a path message sent from an ingress node, for the reservation of the requested path from the ingress node, via intermediate nodes along the path to the node, and
a part arranged to send a resv message back along the path, and to reserve resources for the requested path, for traffic of a signal type specified in G.709 amendment 3 beyond types previously specified by G.709 pre amendment 3,
wherein the path message has an indication of traffic parameters for the requested path including a signal type field, the signal type field having values assigned to indicate traffic types specified in G.709 amendment 3 beyond those specified by G.709 pre amendment 3, without reuse of values specified by G.709 pre amendment 3, so that the node can still distinguish in the signal type field any values of the signal type field specified by G.709 pre amendment 3.

12. A node of an optical transport network having a number of nodes, the node being able to act as an intermediate node in reserving a path for traffic of a type compatible with G709 amendment 3, the node having:
a part arranged to receive and pass on a path message sent from an ingress node, for the reservation of the requested path from the ingress node, via intermediate nodes along the path to an egress node, and
a part arranged to receive and pass on a resv message sent from the egress node back along the path, and to reserve resources for the requested LSP, for traffic of a signal type specified in G.709 amendment 3 beyond types previously specified by G.709 pre amendment 3,
wherein the path message has an indication of traffic parameters for the requested path including a signal type field, the signal type field having values assigned to indicate traffic types specified in G.709 amendment 3 beyond those specified by G.709 pre amendment 3, without reuse of values specified by G.709 pre amendment 3, so that the node can still distinguish in the signal type field any values of the signal type field specified by G.709 pre amendment 3.

13. The node of claim 10, the resv message having an indication of a position of each optical data unit in an optical data unit multiplex structure, to a granularity of approximately 1.25 Gbps or finer.

14. The node of claim 11, being arranged to deduce whether the path message relates to a path for traffic of a signal type specified in G.709 amendment 3 beyond types previously specified by G.709 pre amendment 3, or for traffic of a signal type specified by G.709 pre amendment 3, without the use of a bit in the message dedicated to indicate this.
